(19) United States
(12) Patent Application Publication
(10) Pub. No.: US 2026/0205258 A1
(43) Pub. Date: Jul. 16, 2026

(54) CRYPTOGRAPHIC PROCESSING APPARATUS, CRYPTOGRAPHIC PROCESSING METHOD, AND CRYPTOGRAPHIC PROCESSING PROGRAM

(71) Applicant: NEC Corporation, Tokyo (JP)

(72) Inventors: Hikaru TSUCHIDA, Tokyo (JP); Toshiyuki ISSHIKI, Tokyo (JP); Kengo MORI, Tokyo (JP); Takuya HAYASHI, Tokyo (JP); Yukimasa SUGIZAKI, Tokyo (JP)

(73) Assignee: NEC Corporation, Tokyo (JP)

(21) Appl. No.: 19/136,047

(22) PCT Filed: Dec. 13, 2022
(86) PCT No.: PCT/JP2022/045929

§ 371 Date: Jun. 5, 2025

(51) Int. Cl. H04L 9/00; H04L 9/08

(52) U.S. Cl. CPC H04L 9/008; H04L 9/085

(57) ABSTRACT

A cryptographic processing apparatus relating to a homomorphic encryption on a torus includes: a distributed secret key generation part that generates a distributed secret key; and a correspondence table distribution evaluation part that executes, by using an input-output correspondence table representing a function that receives the distributed secret key and that outputs a value distributed on an algebraic structure different from an algebraic structure on which the secret key is distributed, part of an arithmetic process without decrypting the secret key.

### TECHNICAL FIELD

The present invention relates a cryptographic processing apparatus, a cryptographic processing method, and a cryptographic processing program.

### BACKGROUND ART

There is an encryption technique referred to as “homomorphic encryption”. When ciphertexts Enc(m₁) and Enc(m₂) of plaintexts m₁ and m₂ are given, the homomorphic encryption enables calculation of a ciphertext Enc(m₁∘m₂) of a binary operation m₁∘m₂ of the plaintexts m₁ and m₂, without decrypting the ciphertexts Enc(m₁) and Enc(m₂) to the plaintexts m₁ and m₂. The above “∘” represents a binary operation such as addition “+” or multiplication “×”. The homomorphic encryption regarding addition “+” is referred to as “additive homomorphic encryption”. The homomorphic encryption having homomorphism regarding not only addition “+” but also multiplication “×” is referred to as “fully homomorphic encryption”.

Since the fully homomorphic encryption has homomorphism regarding both addition and multiplication, the fully homomorphic encryption has the best property. However, the fully homomorphic encryption has a weak point that a ciphertext is decrypted if a corresponding decryption key is leaked. To overcome this weak point, there is known a scheme called “threshold fully homomorphic encryption” that executes processes such as key generation and encryption while keeping decryption keys distributed in a secret sharing manner (see Non-Patent Literature 1, for example).

### CITATION LIST

### Non-Patent Literature

NPL1: Boneh, Dan, et al. “Threshold cryptosystems from threshold fully homomorphic encryption.”, Annual International Cryptology Conference. Springer, Chain, 2018.
NPL2: Chillotti, Ilaria, et al. “Faster fully homomorphic encryption: Bootstrapping in less than 0.1 seconds.” In Asiacrypt 2016. NPL3: LAUR, Sven; WILLEMSON, Jan; ZHANG, Bingsheng. Round-efficient oblivious database manipulation. In ISC 2011.

### SUMMARY

### Technical Problem

The disclosure of each of the above-described NPLs is incorporated herein by reference thereto, and the following analysis has been made by the present inventors.

However, since the threshold fully homomorphic encryption executes processes such as key generation and encryption while keeping decryption keys distributed in a secret sharing manner, the algebraic structure on which a ciphertext is expressed and the algebraic structure on which a secret key is expressed need to be identical. However, to make the algebraic structure on which a ciphertext is expressed and the algebraic structure on which a secret key is expressed are identical, the freedom in selecting the algebraic structures needs to be sacrificed. For example, in the fully homomorphic encryption, each time a multiplication is executed on ciphertexts without decrypting the ciphertexts, unnecessary data (noise) is added to the ciphertexts. To remove this noise, it is preferable that the algebraic structure on which a secret key is expressed be mod 2. On the other hand, it is desirable that the algebraic structure on which a ciphertext is expressed be selectable based on characteristics of the plaintext.

Thus, there is a demand for a threshold fully homomorphic encryption that is also applicable to cases in which the algebraic structure on which a ciphertext is expressed and the algebraic structure on which a secret key is expressed are not identical.

The present invention has been made in view of the above problem, and an object of the present invention is to provide a cryptographic processing apparatus, a cryptographic processing method, and a cryptographic processing program that contribute to execution of a threshold fully homomorphic encryption even in cases in which the algebraic structure on which a ciphertext is expressed and the algebraic structure on which a secret key is expressed are not identical.

### Solution to Problem

According to a first aspect of the present invention, there is provided a cryptographic processing apparatus relating to a homomorphic encryption on a torus, the cryptographic processing apparatus including: a correspondence table distribution evaluation part that executes, by using an input-output correspondence table representing a function that receives a distributed secret key and that outputs a value distributed on an algebraic structure different from an algebraic structure on which the secret key is distributed, part of an arithmetic process without decrypting the secret key.

According to a second aspect of the present invention, there is provided a cryptographic processing method relating to a homomorphic encryption on a torus, the cryptographic processing method being executed by an information processing apparatus including a processor and a memory storing commands executed by the processor; wherein the cryptographic processing method including executing, by using an input-output correspondence table representing a function that receives a distributed secret key and that outputs a value distributed on an algebraic structure different from an algebraic structure on which the secret key is distributed, part of an arithmetic process without decrypting the secret key.

According to a third aspect of the present invention, there is provided a cryptographic processing program relating to a homomorphic encryption on a torus, the cryptographic processing program being executed by an information processing apparatus including a processor and a memory storing commands executed by the processor; wherein the cryptographic processing program including a process for executing, by using an input-output correspondence table representing a function that receives a distributed secret key and that outputs a value distributed on an algebraic structure different from an algebraic structure on which the secret key is distributed, part of an arithmetic process without decrypting the secret key.

This program can be recorded in a computer-readable storage medium. The storage medium may be a non-transitory storage medium such as a semiconductor memory, a hard disk, a magnetic recording medium, or an optical recording medium. The present invention can be embodied as a computer program product.

### Advantageous Effects of Invention

According to the individual aspects of the present invention, it is possible to provide a cryptographic processing apparatus, a cryptographic processing method, and a cryptographic processing program that contribute to execution of a threshold fully homomorphic encryption even in cases in which the algebraic structure on which a ciphertext is expressed and the algebraic structure on which a secret key is expressed are not identical.

### BRIEF DESCRIPTION OF DRAWINGS

FIG. 1 is a conceptual diagram illustrating a method for key generation in a threshold fully homomorphic encryption to which the present invention is not applied.

FIG. 2 is a conceptual diagram illustrating a method for ciphertext generation in the threshold fully homomorphic encryption to which the present invention is not applied.

FIG. 3 is a conceptual diagram illustrating a method for a homomorphic operation in the threshold fully homomorphic encryption to which the present invention is not applied.

FIG. 4 is a conceptual diagram illustrating a method for decryption in the threshold fully homomorphic encryption to which the present invention is not applied.

FIG. 5 is a schematic configuration diagram of a cryptographic processing apparatus according to an example embodiment of the present invention.

FIG. 6 is a flowchart illustrating a procedure of a cryptographic processing method according to the example embodiment of the present invention.

FIG. 7 is a diagram illustrating a hardware configuration example of the cryptographic processing apparatus.

FIG. 8 is a schematic diagram illustrating a cryptographic processing apparatus according to an improved example embodiment of the present invention.

### EXAMPLE EMBODIMENTS

Hereinafter, example embodiments of the present invention will be described with reference to drawings. However, the present invention is not limited to the following example embodiments. In addition, in the individual drawings, the same or equivalent elements are denoted by the same reference characters, as needed. The drawings are schematical drawings, and it should be noted that the size relationship between elements, the ratio between elements, etc., may differ from the actual relationship, ratio, etc. These size relationship and ratio may differ between different drawings.

### [Preparation]

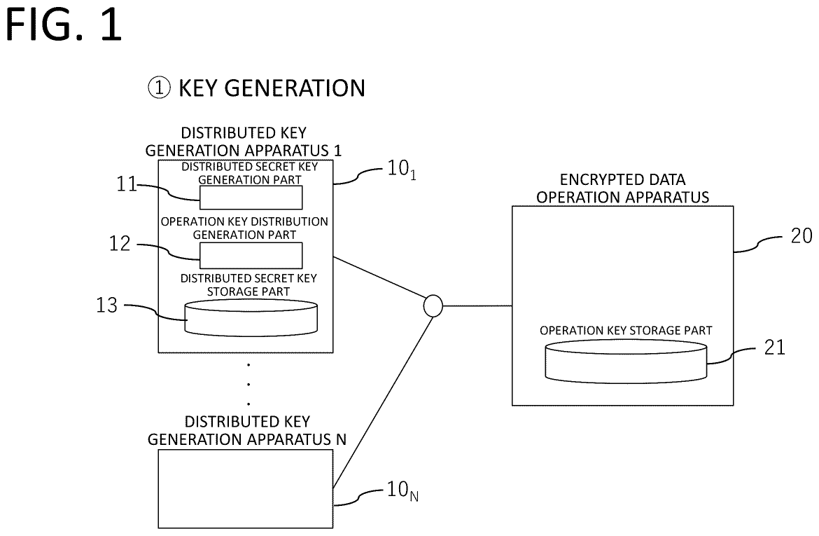

First, a mechanism of a threshold fully homomorphic encryption to which the present invention is not applied will be described. Next, a problem with the threshold fully homomorphic encryption to which the present invention is not applied will be described. That is, a problem that occurs when the algebraic structure on which a ciphertext is expressed and the algebraic structure on which a secret key is expressed are not identical will be described. Finally, how the present invention solves this problem will be described. FIGS. 1 to 4 are each a schematic diagram illustrating a procedure of the threshold fully homomorphic encryption to which the present invention is not applied. The apparatus configuration illustrated in FIGS. 1 to 4 does not limit the application of the present invention.

FIG. 1 is a conceptual diagram illustrating a method for key generation in the threshold fully homomorphic encryption to which the present invention is not applied. As illustrated in FIG. 1, the key generation in this threshold fully homomorphic encryption is executed by a plurality of (N) distributed key generation apparatuses 10₁, . . . , 10_{N}. An individual one of the distributed key generation apparatuses 10₁, . . . , 10_{N} includes a distributed secret key generation part 11, an operation key distribution generation part 12, and a distributed secret key storage part 13. Herein, a distributed secret key is a key used for encrypting a plaintext and decrypting a ciphertext. If a secret key is leaked, a ciphertext is successfully decrypted. Thus, secret sharing is executed on the secret key. The secret key is managed such that the ciphertext cannot be decrypted even if part of the distributed secret key is leaked. That is, after the distributed secret key generation part 11 in an individual one of the distributed key generation apparatuses 10₁, . . . , 10_{N} generates a distributed secret key, the distributed secret key is stored in the distributed secret key storage parts 13 in the distributed key generation apparatuses 10₁, . . . , 10_{N}, without reconstructing the distributed secret key. An operation key is a key that cannot decrypt a ciphertext even if the operation key is leaked. However, the operation key is needed to operate the ciphertext without decrypting the ciphertext. After the operation key distribution generation part 12 in an individual one of the distributed key generation apparatuses 10₁, . . . , 10_{N} generates an operation key, the operation key distribution generation part 12 transmits this operation key to an encrypted data operation apparatus 20. The encrypted data operation apparatus 20 stores the operation key in an operation key storage part 21. At this point, the operation key has already been reconstructed.

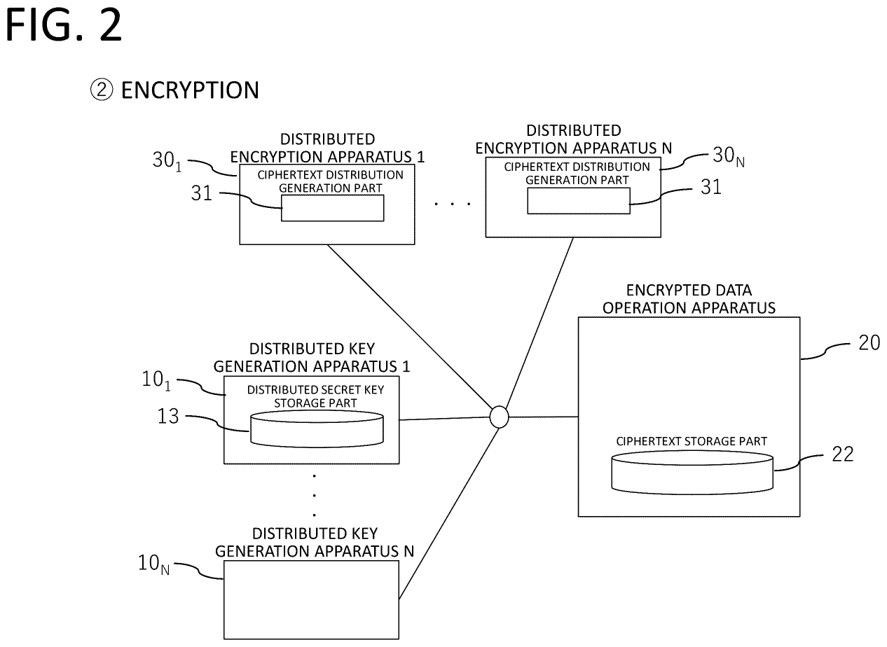

FIG. 2 is a conceptual diagram illustrating a method for ciphertext generation in the threshold fully homomorphic encryption to which the present invention is not applied. As illustrated in FIG. 2, the ciphertext generation in the threshold fully homomorphic encryption is executed by a plurality of (N) distributed encryption apparatuses 30₁, . . . , 30_{N}. The individual one of the distributed encryption apparatuses 30₁, . . . , 30_{N} includes a ciphertext distribution generation part 31. The individual ciphertext distribution generation part 31 acquires a distributed secret key from the distributed secret key storage part 13 in the individual one of the distributed key generation apparatuses 10₁, . . . , 10_{N}. By communicating with each other, the distributed encryption apparatuses 30₁, . . . , 30_{N} each generate a ciphertext without reconstructing the distributed secret key. The generated ciphertext is stored in a ciphertext storage part 22 in the encrypted data operation apparatus 20.

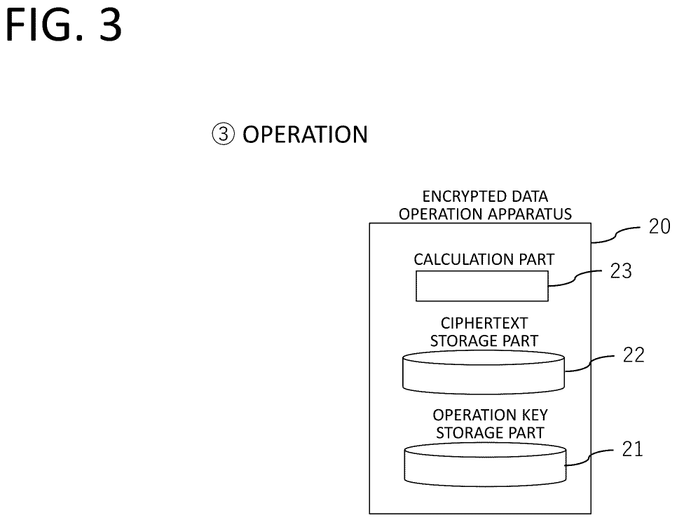

FIG. 3 is a conceptual diagram illustrating a method for a homomorphic operation in the threshold fully homomorphic encryption to which the present invention is not applied. As illustrated in FIG. 3, the homomorphic operation in the threshold fully homomorphic encryption is executed by the encrypted data operation apparatus 20. The encrypted data operation apparatus 20 includes an operation key storage part 21, a ciphertext storage part 22, and a calculation part 23. The encrypted data operation apparatus 20 acquires an operation key stored in the operation key storage part 21 and ciphertexts stored in the ciphertext storage part 22, and enters the operation key and the ciphertexts to the calculation part 23. In this way, the encrypted data operation apparatus 20 can obtain a ciphertext of a result of a calculation executed on encrypted plaintexts, without decrypting the ciphertexts. The obtained ciphertext of the calculation result is stored in the ciphertext storage part 22.

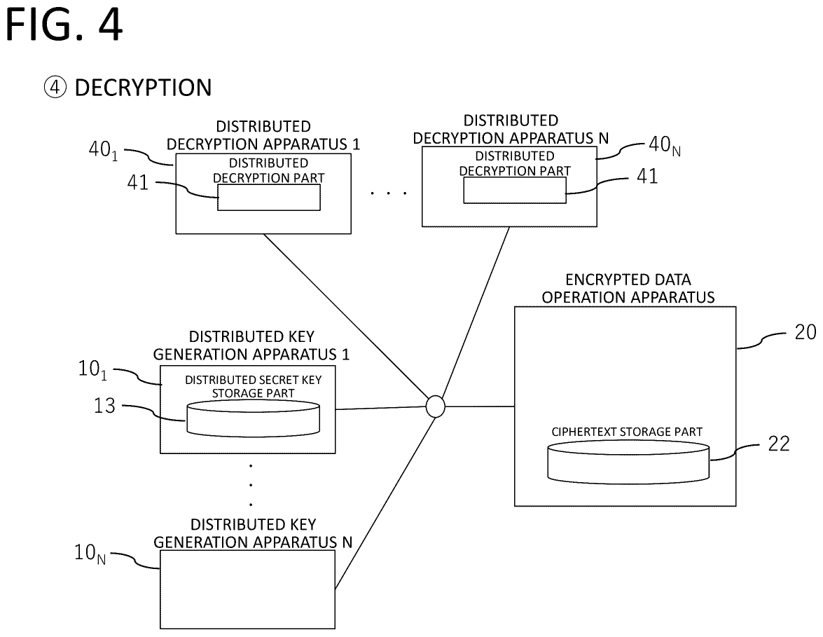

FIG. 4 is a conceptual diagram illustrating a method for decryption in the threshold fully homomorphic encryption to which the present invention is not applied. As illustrated in FIG. 4, the decryption in the threshold fully homomorphic encryption is executed by a plurality of (N) distributed decryption apparatuses 40₁, . . . , 40_{N}. The individual one of the distributed decryption apparatuses 40₁, . . . , 40_{N} includes a distributed decryption part 41. The distributed decryption part 41 acquires a distributed secret key stored in the distributed secret key storage part 13 in the individual one of the distributed key generation apparatuses 10₁, . . . , 10_{N}, and acquires a ciphertext stored in the ciphertext storage part 22 in the encrypted data operation apparatus 20. By communicating with each other, the distributed decryption apparatuses 40₁, . . . , 40_{N} each decrypt a ciphertext, without reconstructing the distributed secret key.

The above processes of the threshold fully homomorphic encryption to which the present invention is not applied are executed as described above. When the algebraic structure on which a ciphertext is expressed and the algebraic structure on which a secret key is expressed are not identical, a problem occurs in “1. Operation Key Distribution Generation”, “2. Ciphertext Distribution Generation”, and “3. Distribution Decryption”. Hereinafter, a problem that occurs when the algebraic structure on which a ciphertext is expressed and the algebraic structure on which a secret key is expressed do not match will be described with reference to an example of “3. Distribution Decryption”.

### (When Algebraic Structures are Identical)

The following explanation will be made on distribution decryption executed when the algebraic structure on which a ciphertext is expressed and the algebraic structure on which a secret key is expressed are identical. The following explanation will be made on an example of distribution decryption executed when each of the algebraic structure on which a ciphertext is expressed and the algebraic structure on which a secret key is expressed is mod q (q is a prime).

The following explanation assumes that a secret key sᵥ=(1, s) and a ciphertext cᵥ=(c, a). In addition, there are relationships between the secret key and the ciphertext as follows: b∈{0, 1}, a, s∈Z_{q}={0, . . . , q−1}, and c=b−a·s mod q. b is a plaintext.

In this case, the distributed key generation apparatuses 10₁ and 10₂ generate a distributed secret key sᵢᵥ=(rᵢ, sᵢ) and store the generated distributed secret key in their respective distributed secret key storage parts 13. The distributed secret key sᵢᵥ=(rᵢ, sᵢ) satisfies the following relationship.

$$1 = {r}_{1} + {r}_{2} mod q ( random numbers satisfying {r}_{1} , {r}_{2} ∈ {ℤ}_{q} ) \qquad [ Equation 1 ]$$

$$s = {s}_{1} + {s}_{2} mod q ( random numbers satisfying {s}_{1} , {s}_{2} ∈ {ℤ}_{q} )$$

$${s}_{v} = {s}_{1 v} + {s}_{2 v}$$

The distributed decryption apparatuses 40₁ and 40₂ acquire distributed secret keys s₁ᵥ=(r₁, s₁) and s₂ᵥ=(r₂, s₂) from the distributed key generation apparatuses 10₁ and 10₂, respectively, acquire the ciphertext cᵥ=(c, a) from the encrypted data operation apparatus 20, and calculate pᵢ.

$${p}_{i} = {c}_{v} \cdot {s}_{i v} = c \cdot {r}_{i} + a \cdot {s}_{i} mod q$$

Next, the distributed decryption apparatuses 40₁ and 40₂ exchange the above-described pᵢ with each other, and calculate p₁+p₂, so as to decrypt the plaintext b.

$${p}_{1} + {p}_{2} = c \cdot ( {r}_{1} + {r}_{2} ) + a \cdot ( {s}_{1} + {s}_{2} ) = c + a \cdot s = b mod q$$

Herein, it is important to note that the operation executed for decrypting the plaintext b is an operation in the algebraic structure on which a ciphertext is expressed (mod q). When the algebraic structure on which a ciphertext is expressed and the algebraic structure on which a secret key is expressed are identical, no problems occur in executing the operation using secret key elements in the algebraic structure on which a ciphertext is expressed (mod q).

(when Algebraic Structures are not Identical)

Next, the following explanation will be made on distribution decryption executed when the algebraic structure on which a ciphertext is expressed and the algebraic structure on which a secret key is expressed are not identical. Herein, the algebraic structure on which a ciphertext is expressed is a torus T (a real number that is 0 or greater and less than 1), and an example of distribution decryption executed when the algebraic structure on which a secret key is expressed is mod 2 will be described.

The following explanation assumes that a secret key sᵥ=(1, s) and a ciphertext cᵥ=(c, a). In addition, there are relationships between the secret key and the ciphertext as follows: s∈{0, 1}, b, a∈T, and c=b−a·s mod 1. b is a plaintext on the torus T.

In this case, the distributed key generation apparatuses 10₁ and 10₂ generate a distributed secret key sᵢᵥ=(rᵢ, sᵢ) and store the generated distributed secret key in their respective distributed secret key storage parts 13. The distributed secret key sᵢᵥ=(rᵢ, sᵢ) satisfies the following relationship.

$$1 = {r}_{1} ⊕ {r}_{2} mod 2 ( random numbers satisfying {r}_{1} , {r}_{2} ∈ {ℤ}_{2} ) \qquad [ Equation 2 ]$$

$$s = {s}_{1} ⊕ {s}_{2} mod 2 ( random numbers satisfying {s}_{1} , {s}_{2} ∈ {ℤ}_{2} )$$

$${s}_{v} = {s}_{1 v} ⊕ {s}_{2 v}$$

The distributed decryption apparatuses 40₁ and 40₂ acquire distributed secret key s₁ᵥ=(r₁, s₁) and s₂ᵥ=(r₂, s₂) from the distributed key generation apparatuses 10₁ and 10₂, respectively, acquire the ciphertext cᵥ=(c, a) from the encrypted data operation apparatus 20, and calculate pᵢ.

$${p}_{i} = {c}_{v} \cdot {s}_{iv} = c \cdot {r}_{i} + a \cdot {s}_{i} mod 1$$

Next, the distributed decryption apparatuses 40₁ and 40₂ exchange the above-described pᵢ with each other, and calculate p₁+p₂. However, the plaintext b cannot be decrypted.

$${p}_{1} + {p}_{2} = c \cdot ( {r}_{1} + {r}_{2} ) + a \cdot ( {s}_{1} + {s}_{2} ) = c + a \cdot s \neq b mod 1$$

This is because the algebraic structure on which a ciphertext is expressed and the algebraic structure on which a secret key is expressed are not identical. In other words, this is because, although the secret key is distributed in the algebraic structure mod 2, an operation in accordance with the algebraic structure mod 1 needs to be executed to decrypt the ciphertext.

For example, when s=0 and s₁=s₂=1, as described below, the calculation results are not identical between the algebraic structure on which a ciphertext is expressed and the algebraic structure on which a secret key is expressed

$$0 = s = 1 ⊕ 1 mod 2 = {s}_{1} ⊕ {s}_{2} mod 2 \qquad [ Equation 3 ]$$

$$a \cdot ( {s}_{1} + {s}_{2} ) = 2 a$$

$$a \cdot ( {s}_{1} ⊕ {s}_{2} ) = 0 ( = a \cdot s )$$

In an example embodiment of the present invention, a technique described below solves the above-described problem that occurs when the algebraic structure on which a ciphertext is expressed and the algebraic structure on which a secret key is expressed are not identical.

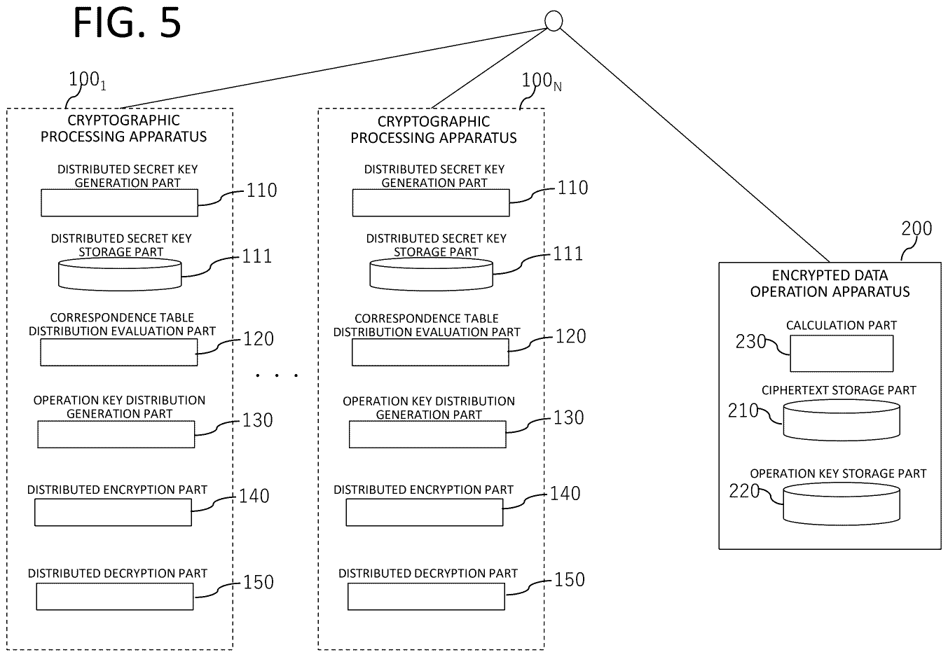

FIG. 5 is a schematic configuration diagram of a cryptographic processing apparatus according to an example embodiment of the present invention. As illustrated in FIG. 5, cryptographic processing apparatuses 100₁, . . . , 100_{N} each include a distributed secret key generation part 110, a distributed secret key storage part 111, a correspondence table distribution evaluation part 120, an operation key distribution generation part 130, a distributed encryption part 140, and a distributed decryption part 150. These distributed secret key generation part 110, distributed secret key storage part 111, correspondence table distribution evaluation part 120, operation key distribution generation part 130, distributed encryption part 140, and distributed decryption part 150 are implemented as functions of the individual cryptographic processing apparatus 100, and do not need to be implemented as independent hardware.

The cryptographic processing apparatuses 100₁, . . . , 100_{N} are each an information processing apparatus that executes an arithmetic process relating to a homomorphic encryption on a torus, and that executes an arithmetic process for encrypting an input plaintext and a process for generating a distributed secret key for the encryption, generating an operation key for a homomorphic operation between ciphertexts, and decrypting a ciphertext. These operation keys and ciphertexts generated by the cryptographic processing apparatuses 100₁, . . . , 100_{N} are transmitted to an encrypted data operation apparatus 200, and are stored in a ciphertext storage part 210 and an operation key storage part 220 in the encrypted data operation apparatus 200. The encrypted data operation apparatus 200 enters ciphertexts stored in the ciphertext storage part 210 and an operation key stored in the operation key storage part 220 to a calculation part 230, and a homomorphic operation is executed between the ciphertexts.

The individual distributed secret key generation part 110 generates a distributed secret key and stores the distributed secret key in the distributed secret key storage parts 111 in the cryptographic processing apparatuses 100₁, . . . , 100_{N} in a secret sharing manner, without reconstructing the distributed secret key.

The individual correspondence table distribution evaluation part 120 executes, by using an input-output correspondence table representing a function that receives a distributed secret key and that outputs a value distributed on an algebraic structure different from an algebraic structure on which the secret key is distributed, part of an arithmetic process without decrypting the secret key. The arithmetic process using the correspondence table will be described in detail below with reference to a particular example.

The individual operation key distribution generation part 130 generates an operation key for operating a ciphertext distributed on the algebraic structure different from the algebraic structure on which the secret key is distributed, without decrypting the ciphertext. Part of the arithmetic process for the generation of the operation key is executed by the correspondence table distribution evaluation part 120.

The individual distributed encryption part 140 generates, from a plaintext, a ciphertext distributed on the algebraic structure different from the algebraic structure on which the secret key is distributed. Part of the arithmetic process for the encryption is executed by the correspondence table distribution evaluation part 120.

The individual distributed decryption part 150 decrypts a ciphertext distributed on the algebraic structure different from the algebraic structure on which the secret key is distributed. Part of the arithmetic process for the decryption is executed by the correspondence table distribution evaluation part 120.

Next, particular examples of “1. Operation Key Distribution Generation”, “2. Ciphertext Distribution Generation”, and “3. Distribution Decryption” using the cryptographic processing apparatuses 100₁, . . . , 100_{N} will be described. Although the following cryptographic technique will be described below by using the cryptographic technique described in NPL2 as a reference, the basic technical concept of the present invention is not limited to a particular cryptographic technique.

The fully homomorphic encryption described in NPL2 is constituted by the following six algorithms. Herein, in order to create a threshold fully homomorphic encryption based on the fully homomorphic encryption described in NPL2, the six algorithms are modified as follows.
1. param←Setup(1^{λ}) in which 1^{λ} represents a security parameter, and param is a public parameter.
2. SK←SK_Gen(param) in which SK represents a secret key.
3. (BSK, KSK)←EK_Gen(param, SK) in which BSK represents a bootstrap key, and KSK represents a key switching key.
4. c←Enc(m, SK) in which m represents a plaintext, and c represents a ciphertext.
5. c′←Eval(c₀, c₁, op, BSK, KSK) in which c₀ and c₁ represent ciphertexts, and op represents designation of an operation.
6. m←Dec(c, SK) in which c represents a ciphertext. This is a decryption process using the secret key SK.

### 1. Setting of Public Parameter Param

This process can be executed without causing the cryptographic processing apparatuses 100₁, . . . , 100_{N} to communicate with each other, irrespective of the algebraic structure on which a secret key is distributed and the algebraic structure on which a ciphertext is expressed.

### 2. Distribution Generation of Secret Key

Shares [SK]=([s₁], . . . , [s_{n′}]) of the secret key SK=(s₁, . . . , s_{n′})∈{0,1}^{n′} can be generated without communications. Particularly, the individual one of the cryptographic processing apparatuses 100₁, . . . , 100_{N} generates random numbers r_{i′}, i∈{0, 1}, and sets [s_{i′}]ᵢ=r_{i′}, i (for i′=1, . . . , n′; i=1, . . . , n−1). That is, the following relationship is established.

$${s}_{{i}^{′}} = {r}_{{i}^{′} , 0} ⊕ ⋯ ⊕ {r}_{{i}^{′} , n - 1} \qquad [ Equation 4 ]$$

K=Σ_{j′=0}^{N-1}Kⱼ·X^{j′}∈B_{N}[X] necessary for calculating the BSK can also be generated as [K]=([K₀], . . . , [K_{N-1}]) for coefficient portions, without causing the cryptographic processing apparatuses 100₁, . . . , 100_{N} to communicate with each other.

### 3. Generation of BSK and KSK

The BSK in the threshold fully homomorphic encryption is set as BSK=(B₁, . . . , B_{n′}). Herein, Bᵢ=TRGSW_{K}(sᵢ), sᵢ is an element of the secret key SK∈{0,1}ⁿ, and K∈(B_{N}[X])^{k}. TRGSW is a GSW ciphertext having an element on T_{N}[X]. TRGSW_{K}(sᵢ) is a TRGSW ciphertext obtained by encrypting sᵢ with a secret key K, and can be calculated as follows.

$${TRGSW}_{\vert K \vert} ( {s}_{i} ) = {s}_{i} \cdot ( \begin{matrix}B ( {B}_{g} , ℓ ) & 0 & ⋯ & 0 \\ 0 & B ( {B}_{g} , ℓ ) & ⋯ & 0 \\ ⋮ & ⋱ & ⋱ & ⋮ \\ 0 & ⋯ & 0 & B ( {B}_{g} , ℓ )\end{matrix} ) + ( \begin{matrix}{z}_{1} \\ ⋮ \\ {z}_{ℓ ( k + 1 )}\end{matrix} )$$

$$B ( {B}_{g} , ℓ ) := ( \begin{matrix}{B}_{g}^{- 1} \\ ⋮ \\ {B}_{g}^{- ℓ}\end{matrix} ) ,$$

z_{i′} is ciphertext of TRLWE_{|K|}(0) (for i′=1, . . . [symbol] (k+1)) However, B_{g} and l are the base and the number of digits of the decomposition.

In addition, the KSK in the threshold fully homomorphic encryption is set as follows.

$$KSK = {\{ {SW}_{i , j} \}}_{i = 1 , j = 1}^{N ; t} \qquad [ Equation 6 ]$$

$${SW}_{i , j} = {TLWE}_{SK} ( \frac{{K}_{i - 1}}{{2}^{j}} ) for i = 1 , … , N ; j = 1 , … , t$$

In the explanation of the BSK, K=(K₀, . . . , Kₖ₋₁)∈(B_{N}[X])^{k} has been used. Hereinafter, a setting in which k=1 will be considered. This case assumes that K=K_{N-1}X^{N-1}+ . . . +K₁X+K₀∈B_{N}[X].

The KSK is generated as follows. First, K=(K₁, . . . , K_{N-1})∈B^{N} can be generated in the same way as the secret key SK. From the above-described definition, the KSK needs [[Kᵢ₋₁/2^{j}]] distributed on the algebraic structure on which a ciphertext is expressed. This [[Kᵢ₋₁/2^{j}]] can be calculated by using a correspondence table configured as described below. Heren, “shuffle” is a technique described in NPL3. By executing shuffle on the row indexes among the row and column indexes, it is possible to execute a shuffle operation while fixing the columns. In addition, the algebraic structure on which a ciphertext is expressed [[ ]] is additive secret sharing on a torus. When [[x]]=([[x]]₀, . . . , [[x]]ₙ₋₁), additive sharing on a torus is achieved such that x=x₀+ . . . +xₙ₋₁ mod 1 xᵢ∈T is satisfied.

TABLE 1

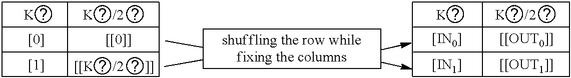

[symbol]

[symbol]

indicates data missing or illegible when filed

The following calculation is executed by using this correspondence table.

$$[ {c}_{0} ] = [ {K}_{i - 1} ] ⊕ [ {IN}_{0} ] , [ {c}_{1} ] = [ {K}_{i - 1} ] ⊕ [ {IN}_{1} ] \qquad [ Equation 7 ]$$

Next, c₀ and c₁ are reconstructed. Since Kᵢ₋₁=IN_{b} when c_{b}=0, [[OUT_{b}]] in the corresponding row is selected. Assuming this [[OUT_{b}]] as [[Kᵢ₋₁/2^{j}]], [[SW_{i,j}]] is calculated. That is, in the above-described correspondence table, the input candidate [Kᵢ₋₁] of the distributed secret key and the output candidate [[Kᵢ₋₁/2^{j}]] distributed on the algebraic structure different from the algebraic structure on which the secret key is distributed are listed in a single row, and the output candidate [[OUT₁]] in the row that matches the input of the distributed secret key is selected. In this way, the problem caused by the inconsistency between the algebraic structure on which a secret key is expressed and the algebraic structure on which a ciphertext is expressed is avoided, and the target numerical value [[SW_{i,j}]] is acquired.

As described above, the correspondence table distribution evaluation part 120 in the individual one of the cryptographic processing apparatuses 100₁, . . . , 100_{N} executes, by using an input-output correspondence table representing a function that receives a distributed secret key K=(K₁, . . . , K_{N}) and that outputs a value [[Kᵢ₋₁/2^{j}]] distributed on an algebraic structure different from an algebraic structure on which the secret key is distributed, part of an arithmetic process without decrypting the secret key. Thus, it is possible to generate an operation key KSK for operating a ciphertext distributed on the algebraic structure different from the algebraic structure on which the secret key is distributed, without decrypting the ciphertext.

The BSK is generated as follows. As described above, the BSK in the threshold fully homomorphic encryption is set as BSK=(B₁, . . . , B_{n′}), and Bᵢ=TRGSW_{K}(sᵢ) is calculated. Herein, since Bᵢ=TRGSW_{K}(sᵢ) is calculated as described above, the following two elements are calculated. Herein, < > represents an algebraic structure on which a ciphertext is expressed, particularly, additive secret sharing on a polynomial ring having elements on a torus as coefficients. When <a>=(<a>₀, . . . , <a>ₙ₋₁), the distribution is achieved by an operation of a polynomial ring T_{N}[X] on a torus such that a=a₀+ . . . +aₙ₋₁ is satisfied.

$$( \begin{matrix}〈 {s}_{i} \cdot B ( {B}_{g} , ℓ ) 〉 & 〈 0 〉 & ⋯ & 〈 0 〉 \\ 〈 0 〉 & 〈 {s}_{i} \cdot B ( {B}_{g} , ℓ ) 〉 & ⋯ & 〈 0 〉 \\ ⋮ & ⋱ & ⋱ & ⋮ \\ 〈 0 〉 & ⋯ & 〈 0 〉 & 〈 {s}_{i} \cdot B ( {B}_{g} , ℓ ) 〉\end{matrix} ) , ( \begin{matrix}〈 {z}_{1} 〉 \\ ⋮ \\ 〈 {z}_{2 ℓ} 〉\end{matrix} ) \qquad [ Equation 8 ]$$

First, because <0> can be calculated obviously, 0 is simply set. On the other hand, <sᵢ·B(B_{g}, l)> is calculated by using the following correspondence table.

TABLE 2

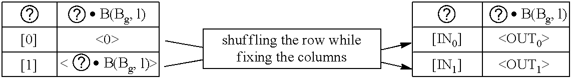

[symbol]

[symbol]

indicates data missing or illegible when filed

By using this correspondence table, the following calculation is executed.

$$[ {c}_{0} ] = [ {s}_{{i}^{′}} ] ⊕ [ {IN}_{0} ] , [ {c}_{1} ] = [ {s}_{{i}^{′}} ] ⊕ [ {IN}_{1} ] \qquad [ Equation 9 ]$$

Next, c₀ and c₁ are reconstructed. Since Sᵢ=IN_{b} when c_{b}=0, <OUT_{b}> in the corresponding row is selected. Assuming this <OUT_{b}> as <sᵢB(B_{g}, l)>, the above matrix is calculated.

In addition, calculation is executed with the following correspondence table, assuming that <Zᵢ . . . > is a ciphertext of TRLWEₖ(0) (for i″=1, . . . , 21).

TABLE 3

| K [symbol] | $K \text{?} X \text{?} \cdot \sum \text{?} a \text{?} X \text{?}$ $\text{?} \text{indicates text missing or illegible when filed}$ | | K [symbol] | $K \text{?} X \text{?} \cdot \sum \text{?} a \text{?} X \text{?}$ $\text{?} \text{indicates text missing or illegible when filed}$ |
|---|---|---|---|---|
| [0] | <0> | 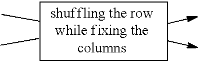 | <INT₀> | <OUT₀> |
| [1] | $〈 K \text{?} X \text{?} \cdot \sum \text{?} a \text{?} X \text{?} 〉$ $\text{?} \text{indicates text missing or illegible when filed}$ | | <IN₁> | <OUT₁> |

[symbol]

indicates data missing or illegible when filed

By using this correspondence table, the following calculation is executed.

$$[ {c}_{0} ] = [ {K}_{{i}^{′}} ] ⊕ [ {IN}_{0} ] , [ {c}_{1} ] = [ {K}_{{i}^{′}} ] ⊕ [ {IN}_{1} ] \qquad [ Equation 10 ]$$

Next, c₀ and c₁ are reconstructed. Since K_{i′}=IN_{b} when c_{b}=0, <OUT_{b}> in the corresponding row is selected. This process is executed for i′=1, . . . , n′. The random number share <e> is added to each <OUT_{b}> obtained, so as to obtain <Zᵢ, . . . >.

Finally, by using the obtained <sᵢ·B(B_{g}, l)> and <Zᵢ . . . >, <BSK> is calculated as follows.

$$〈 {B}_{{i}^{′}} 〉 = 〈 {TRGSW}_{K} ( {s}_{{i}^{′}} ) 〉 = ( \begin{matrix}〈 {s}_{i} \cdot B ( {B}_{g} , ℓ ) 〉 & 〈 0 〉 \\ 〈 0 〉 & 〈 {s}_{i} \cdot B ( {B}_{g} , ℓ ) 〉\end{matrix} ) + ( \begin{matrix}〈 {z}_{1} 〉 \\ ⋮ \\ 〈 {z}_{2 ℓ} 〉\end{matrix} ) , \qquad [ Equation 11 ]$$

$$〈 BSK 〉 = ( 〈 {B}_{1} 〉 , … , 〈 {B}_{{n}^{′}} 〉 )$$

As described above, the correspondence table distribution evaluation part 120 in the individual one of the cryptographic processing apparatuses 100₁, . . . , 100_{N} executes, by using an input-output correspondence table representing a function that receives a distributed secret key K=(K₀, . . . , K_{N-1}) and that outputs values <sᵢ·B(B_{g}, l)> and <Zᵢ . . . > distributed on an algebraic structure different from an algebraic structure on which the secret key is distributed, part of an arithmetic process without decrypting the secret key. Thus, it is possible to generate an operation key BSK for operating a ciphertext distributed on the algebraic structure different from the algebraic structure on which the secret key is distributed, without decrypting the ciphertext.

### 4. Distribution Generation of Ciphertext

A ciphertext of a plaintext p in the threshold fully homomorphic encryption is obtained as follows.

$$〚 c 〛 = {{〚 μ 〛}^{+} 〚 S K \cdot \vec{a} 〛}^{+} 〚 e 〛 \qquad [ Equation 12 ]$$

$$〚 {TLWE}_{SK} ( μ ) 〛 = ( \vec{〚 a 〛} = ( 〚 {a}_{1} 〛 , … , 〚 {a}_{{n}^{′}} 〛 ) , 〚 c 〛 )$$

The secret key SK, [[aᵢ·]], share [e] in the random number term, and [[SK·a]] are acquired as follows.

As a preparation, distribution generation of the secret key SK, [[aᵢ·]], and distribution [[μ]] of the plaintext μ can be obtained as described above. The share [[e]] in the random number term is selected by generating a random number table of a modular normal distribution χ_{(0, σ2)} and by shuffling this. In addition, [[SK·a]] is calculated by using the following correspondence table.

TABLE 4

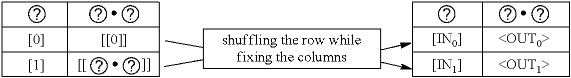

[symbol]

[symbol]

indicates data missing or illegible when filed

By using this correspondence table, the following calculation is executed.

$$[ {c}_{0} ] = [ {s}_{{i}^{′}} ] ⊕ [ {IN}_{0} ] , [ {c}_{1} ] = [ {s}_{{i}^{′}} ] ⊕ [ {IN}_{1} ] \qquad [ Equation 13 ]$$

Next, c₀ and c₁ are reconstructed. Since sᵢ=IN_{b} when c_{b}=0, <OUT_{b}> in the corresponding row is selected. This process is executed in parallel n′ times. By calculating a sum of the selected [[OUT_{b}]], [[SK·a]] is obtained. By assigning the obtained [[SK·a]], distribution [[μ]] of plaintext μ, and share [[e]] in the random number term to the above definition equation, distribution generation of the ciphertext is completed.

As described above, the correspondence table distribution evaluation part 120 in the individual one of the cryptographic processing apparatuses 100₁, . . . , 100_{N} executes, by using an input-output correspondence table representing a function that receives a distributed secret key SK=(s₁, . . . , s_{N}) and that outputs a value [[SK·a]] distributed on an algebraic structure different from an algebraic structure on which the secret key is distributed, part of an arithmetic process without decrypting the secret key. Thus, it is possible to generate a ciphertext distributed on the algebraic structure different from the algebraic structure on which the secret key is distributed.

### 5. Distribution Decryption of Ciphertext

To decrypt the plaintext p from the ciphertext c, the following calculation needs to be executed.

$$〚 μ + e + {e}^{′} 〛 = c - 〚 S K \cdot \vec{a} 〛 + 〚 {e}^{′} 〛 \qquad [ Equation 14 ]$$

The share [e′] in the random number term and [[SK·a]] are acquired as follows.

The share [[e′]] in the random number term is selected by generating a random number table of a modular normal distribution χ_{(0,σ2)} and by shuffling this. In addition, [[SK·a]] is calculated by using the correspondence table simultaneously with the above-described ciphertext generation. The share in the random number term may be generated by an auxiliary server, without using the random number table.

By assigning the obtained [[SK·a]], share [[e′]] in the random number term, and ciphertext c to the above equation, [[μ+e+e′]] may be obtained. Next, by decrypting this, μ+e+e′ is obtained. Herein, e+e′ is not needed to obtain the plaintext μ. However, taking |e+e′|<⅛ into consideration, the plaintext μ can be obtained by checking whether μ is closer to 0 or ¼.

As described above, the correspondence table distribution evaluation part 120 in the individual one of the cryptographic processing apparatuses 100₁, . . . , 100_{N} executes, by using an input-output correspondence table representing a function that receives a distributed secret key SK=(s₁, . . . , s_{N}) and that outputs a value [[SK·a]] distributed on an algebraic structure different from an algebraic structure on which the secret key is distributed, part of an arithmetic process without decrypting the secret key. Thus, it is possible to decrypt a ciphertext distributed on the algebraic structure different from the algebraic structure on which the secret key is distributed.

### [Cryptographic Processing Method]

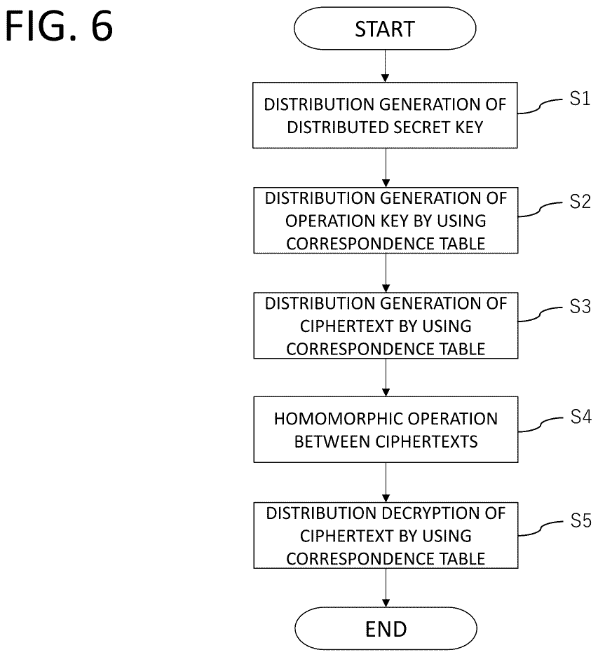

FIG. 6 is a flowchart illustrating a procedure of a cryptographic processing method according to the example embodiment of the present invention. The cryptographic processing method will be described below based on the configuration of the cryptographic processing apparatuses 100₁, . . . , 100_{N}. However, the cryptographic processing method can be executed appropriately by an information processing apparatus including a processor and a memory storing a program executed by the processor.

As illustrated in FIG. 6, the cryptographic processing method includes a step of distribution generation of a distributed secret key (step S1), a step of distribution generation of an operation key (step S2), a step of distribution generation of a ciphertext (step S3), a step of a homomorphic operation between ciphertexts (step S4), and a step of distribution decryption of a ciphertext (step S5).

In the step of distribution generation of a distributed secret key (step S1), a distributed secret key is generated. The distributed secret key is stored in the distributed secret key storage part Ill in the individual one of the cryptographic processing apparatuses 100₁, . . . , 100_{N} in a secret sharing manner, without reconstructing the distributed secret key. In the distribution generation of the distributed secret key, a process that depends on the inconsistency with the algebraic structure of the ciphertext is not executed. However, an algebraic structure different from the algebraic structure on which the distributed secret key is expressed is selected.

In the step of distribution generation of an operation key (step S2), an operation key for operating a ciphertext distributed on the algebraic structure different from the algebraic structure on which the secret key is distributed is generated, without decrypting the ciphertext. Part of the arithmetic process for generating the operation key is executed by the correspondence table distribution evaluation part 120. The correspondence table distribution evaluation part 120 executes, by using an input-output correspondence table representing a function that receives a distributed secret key and that outputs a value distributed on an algebraic structure different from an algebraic structure on which the secret key is distributed, part of the arithmetic process without decrypting the secret key.

In the step of distribution generation of a ciphertext (step S3), a ciphertext distributed on the algebraic structure different from the algebraic structure on which the secret key is distributed is generated from a plaintext. Part of the arithmetic process for the encryption is executed by the correspondence table distribution evaluation part 120. The correspondence table distribution evaluation part 120 executes, by using an input-output correspondence table representing a function that receives a distributed secret key and that outputs a value distributed on an algebraic structure different from an algebraic structure on which the secret key is distributed, part of the arithmetic process without decrypting the secret key.

In the step of a homomorphic operation between ciphertexts (step S4), a homomorphic operation is executed between ciphertexts. In this process itself, the inconsistency between the algebraic structure on which a secret key is expressed and the algebraic structure on which a ciphertext is expressed is not a problem.

In the step of distribution decryption of a ciphertext (step S5), a ciphertext distributed on the algebraic structure different from the algebraic structure on which the secret key is distributed is decrypted. Part of the arithmetic process for the decryption is executed by the correspondence table distribution evaluation part 120. The correspondence table distribution evaluation part 120 executes, by using an input-output correspondence table representing a function that receives a distributed secret key and that outputs a value distributed on an algebraic structure different from an algebraic structure on which the secret key is distributed, part of the arithmetic process without decrypting the secret key.

### Hardware Configuration Example

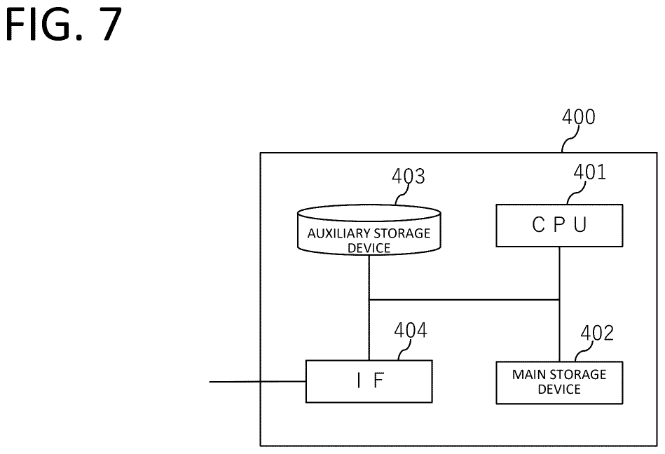

FIG. 7 is a diagram illustrating a hardware configuration example of a cryptographic processing apparatus. An information processing apparatus (a computer) that adopts the hardware configuration illustrated in FIG. 7 can realize functions of the cryptographic processing apparatus described above. However, the hardware configuration example illustrated in FIG. 7 is an example of the hardware configuration that realizes the functions of the individual one of the cryptographic processing apparatuses 100₁, . . . , 100_{N}. That is, the hardware configuration of the individual one of the cryptographic processing apparatuses 100₁, . . . , 100_{N} is not limited to the example illustrated in FIG. 7. The cryptographic processing apparatuses 100₁, . . . , 100_{N} may include hardware not illustrated in FIG. 7.

As illustrated in FIG. 7, a hardware configuration 400 that can be adopted by the individual one of the cryptographic processing apparatuses 100₁, . . . , 100_{N} includes a CPU (Central Processing Unit) 401, a main storage device 402, an auxiliary storage device 403, and an IF (Interface) part 404, which are mutually connected via an internal bus, for example.

The CPU 401 executes individual commands included in a program executed by the cryptographic processing apparatus. The main storage device 402 is, for example, a RAM (Random Access Memory), and temporarily stores, for example, various kinds of programs executed by the individual cryptographic processing apparatuses 100₁, . . . , 100_{N}. These programs are processed by the CPU 40₁.

The auxiliary storage device 403 is, for example, an HDD (Hard Disk Drive) and can store, for example, various kinds of programs executed by the individual cryptographic processing apparatuses 100₁, . . . , 100_{N} in the mid to long term. Various kinds of programs can be each provided as a program product recorded in a non-transitory computer-readable storage medium. The auxiliary storage device 403 can be used to store various kinds of programs recorded in the non-transitory computer-readable storage medium in the mid to long term. The IF part 404 provides an interface relating to the communications performed between the cryptographic processing apparatuses 100₁, . . . , 100_{N} and the encrypted data operation apparatus 200.

The information processing apparatus that adopts the hardware configuration 400 as described above can realize the individual functions of the individual one of the cryptographic processing apparatuses 100₁, . . . , 100_{N}.

Part or all of the above-described example embodiments can also be described as, but not limited to, the following notes.

### Improved Example Embodiment

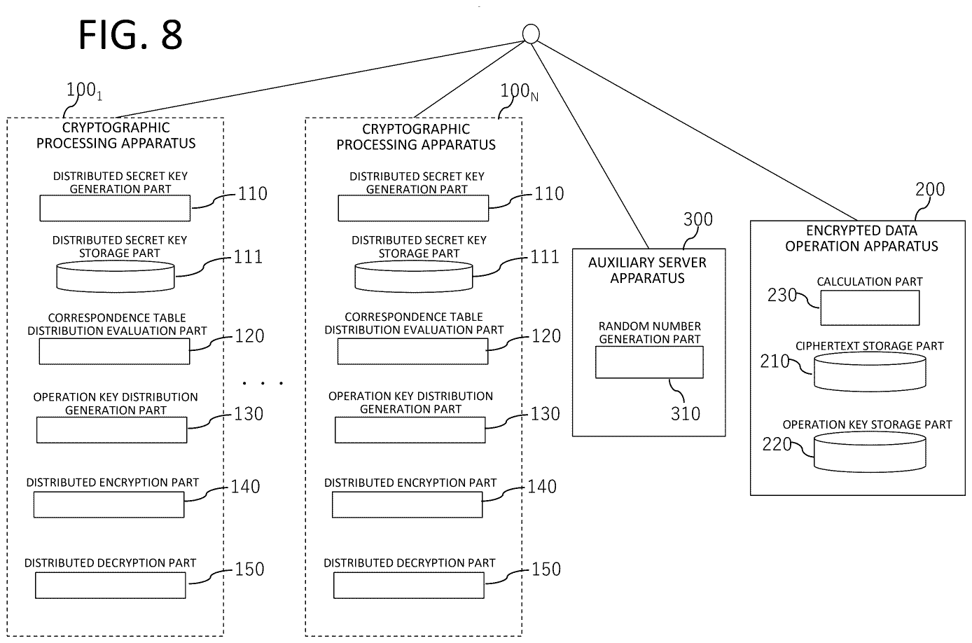

FIG. 8 is a schematic diagram illustrating a cryptographic processing apparatus according to an improved example embodiment of the present invention. As illustrated in FIG. 8, cryptographic processing apparatuses 100₁, . . . , 100_{N} each include a distributed secret key generation part 110, a distributed secret key storage part 111, a correspondence table distribution evaluation part 120, an operation key distribution generation part 130, a distributed encryption part 140, and a distributed decryption part 150, as is the case with the above-described example embodiment. These distributed secret key generation part 110, distributed secret key storage part 111, correspondence table distribution evaluation part 120, operation key distribution generation part 130, distributed encryption part 140, and distributed decryption part 150 are implemented as functions of the individual cryptographic processing apparatus 100, and do not need to be implemented as independent hardware.

In addition, as is the case with the above example embodiment, the cryptographic processing apparatuses 100₁, . . . , 100_{N} are each an information processing apparatus that executes an arithmetic process relating to a homomorphic encryption on a torus, and that executes an arithmetic process for encrypting an input plaintext and a process for generating a distributed secret key for the encryption, generating an operation key for a homomorphic operation between ciphertexts, and decrypting a ciphertext. These operation keys and ciphertexts generated by the cryptographic processing apparatuses 100₁, . . . , 100_{N} are transmitted to an encrypted data operation apparatus 200, and are stored in a ciphertext storage part 210 and an operation key storage part 220 in the encrypted data operation apparatus 200. The encrypted data operation apparatus 200 enters ciphertexts stored in the ciphertext storage part 210 and an operation key stored in the operation key storage part 220 to a calculation part 230, and a homomorphic operation is executed between the ciphertexts.

As is the case with the correspondence table distribution evaluation part 120 according to the above-described example embodiment, the process for distribution encryption and the process for distribution decryption need the shares [[e]] and [[e′]] of random numbers. However, generating the shares [[e]] and [[e′]] of the random numbers based on a distribution in accordance with the definition increases the table size, thereby deteriorating the efficiency.

In the case of the cryptographic processing apparatuses 100₁, . . . , 100_{N} according to the improved example embodiment, to avoid this deterioration in efficiency, an auxiliary server apparatus 300 that generates the shares [[e]] and [[e′]] of the random numbers and distributes these shares among the cryptographic processing apparatuses 100₁, . . . , 100_{N} is separately prepared. The auxiliary server apparatus 300 includes a random number generation part 310. This random number generation part 310 generates random numbers e and e′ in advance, and distributes the shares [[e]] and [[e′]] of the random numbers among the cryptographic processing apparatuses 100₁, . . . , 100_{N}. The auxiliary server apparatus 300 only generates the random numbers e and e′ and distributes the shares [[e]] and [[e′]] of the random numbers among the cryptographic processing apparatuses 100₁, . . . , 100_{N}, and does not change the contents of the cryptographic processes executed by the cryptographic processing apparatuses 100₁, . . . , 100_{N}.

Part or all of the above-described example embodiments can also be described as, but not limited to, the following notes.

### Note 1

A cryptographic processing apparatus relating to a homomorphic encryption on a torus, the cryptographic processing apparatus including: a correspondence table distribution evaluation part that executes, by using an input-output correspondence table representing a function that receives a distributed secret key and that outputs a value distributed on an algebraic structure different from an algebraic structure on which the secret key is distributed, part of an arithmetic process without decrypting the secret key.

### Note 2

The cryptographic processing apparatus according to note 1; wherein the arithmetic process executed by the correspondence table distribution evaluation part is a process for decrypting a ciphertext distributed on the algebraic structure different from the algebraic structure on which the secret key is distributed.

### Note 3

The cryptographic processing apparatus according to note 1 or 2; wherein the arithmetic process executed by the correspondence table distribution evaluation part is a process for generating, from a plaintext, a ciphertext distributed on the algebraic structure different from the algebraic structure on which the secret key is distributed.

### Note 4

The cryptographic processing apparatus according to any one of notes 1 to 3; wherein the arithmetic process executed by the correspondence table distribution evaluation part is a process for generating an operation key for operating a ciphertext distributed on the algebraic structure different from the algebraic structure on which the secret key is distributed, without decrypting the ciphertext.

### Note 5

The cryptographic processing apparatus according to any one of notes 1 to 4;
wherein in the correspondence table, an input candidate of the distributed secret key and an output candidate distributed on the algebraic structure different from the algebraic structure on which the secret key is distributed are listed in a single row; and
wherein the correspondence table distribution evaluation part selects an output candidate in a row that matches input of the distributed secret key.

### Note 6

A cryptographic processing method relating to a homomorphic encryption on a torus, the cryptographic processing method being executed by an information processing apparatus including a processor and a memory storing commands executed by the processor;
wherein the cryptographic processing method including executing, by using an input-output correspondence table representing a function that receives a distributed secret key and that outputs a value distributed on an algebraic structure different from an algebraic structure on which the secret key is distributed, part of an arithmetic process without decrypting the secret key.

### Note 7

The cryptographic processing method according to note 6; wherein the arithmetic process is a process for decrypting a ciphertext distributed on the algebraic structure different from the algebraic structure on which the secret key is distributed.

### Note 8

The cryptographic processing method according to note 6 or 7; wherein the arithmetic process is a process for generating, from a plaintext, a ciphertext distributed on the algebraic structure different from the algebraic structure on which the secret key is distributed.

### Note 9

The cryptographic processing method according to any one of notes 6 to 8; wherein the arithmetic process is a process for generating an operation key for operating a ciphertext distributed on the algebraic structure different from the algebraic structure on which the secret key is distributed, without decrypting the ciphertext.

### Note 10

A cryptographic processing program relating to a homomorphic encryption on a torus, the cryptographic processing program being executed by an information processing apparatus including a processor and a memory storing commands executed by the processor;
wherein the cryptographic processing program including a process for executing, by using an input-output correspondence table representing a function that receives a distributed secret key and that outputs a value distributed on an algebraic structure different from an algebraic structure on which the secret key is distributed, part of an arithmetic process without decrypting the secret key.

In the present invention, if an algorithm, software, a flowchart, or an automated process step is indicated, it is obvious that a computer is used. It is also obvious that the computer is provided with a processor and a memory or a storage device. Thus, even if these elements are not explicitly described, it shall be understood that these elements have, of course, been described in the present application.

The disclosure of the above NPLs, etc., which have been referred to, is incorporated herein by reference thereto. Modifications and adjustments of the example embodiments and examples are possible within the scope of the overall disclosure (including the claims) of the present invention and based on the basic technical idea of the present invention. Various combinations and selections (including partial deletions) of various disclosed elements (including the elements in each of the claims, example embodiments, examples, drawings, etc.) are possible within the scope of the overall disclosure of the present invention. That is, the present invention, of course, includes various variations and modifications that could be made by those skilled in the art according to the overall disclosure including the claims and the technical idea. The specification discloses numerical value ranges. However, even if the specification does not particularly disclose numerical values or small ranges included in the ranges, these values and ranges should be deemed to have been specifically disclosed. In addition, as needed and based on the gist of the present invention, partial or entire use of the individual disclosed matters in the above literatures that have been referred to in combination with what is disclosed in the present application should be deemed to be included in what is disclosed in the present application, as part of the disclosure of the present invention.

### REFERENCE SIGNS LIST

10₁, . . . , 10_{N} distributed key generation apparatus
11 distributed secret key generation part
12 operation key distribution generation part
13 distributed secret key storage part
20 encrypted data operation apparatus
21 operation key storage part
22 ciphertext storage part
30₁, . . . , 30_{N} distributed encryption apparatus
31 ciphertext distribution generation part
40₁, . . . , 40_{N} distributed decryption apparatus
41 distributed decryption part
100₁, . . . , 100_{N} cryptographic processing apparatus
110 distributed secret key generation part
111 distributed secret key storage part
120 correspondence table distribution evaluation part
130 operation key distribution generation part
140 distributed encryption part
150 distributed decryption part
400 hardware configuration
401 CPU (Central Processing Unit)
402 main storage device
403 auxiliary storage device
404 IF (Interface) part

What is claimed is:

1. A cryptographic processing apparatus relating to a homomorphic encryption on a torus, the cryptographic processing apparatus comprising:
a correspondence table distribution evaluation part that executes, by using an input-output correspondence table representing a function that receives a distributed secret key and that outputs a value distributed on an algebraic structure different from an algebraic structure on which the secret key is distributed, part of an arithmetic process without decrypting the secret key.

2. The cryptographic processing apparatus according to claim 1; wherein the arithmetic process executed by the correspondence table distribution evaluation part is a process for decrypting a ciphertext distributed on the algebraic structure different from the algebraic structure on which the secret key is distributed.

3. The cryptographic processing apparatus according to claim 1; wherein the arithmetic process executed by the correspondence table distribution evaluation part is a process for generating, from a plaintext, a ciphertext distributed on the algebraic structure different from the algebraic structure on which the secret key is distributed.

4. The cryptographic processing apparatus according to claim 1; wherein the arithmetic process executed by the correspondence table distribution evaluation part is a process for generating an operation key for operating a ciphertext distributed on the algebraic structure different from the algebraic structure on which the secret key is distributed, without decrypting the ciphertext.

5. The cryptographic processing apparatus according to claim 1;
wherein in the correspondence table, an input candidate of the distributed secret key and an output candidate distributed on the algebraic structure different from the algebraic structure on which the secret key is distributed are listed in a single row; and
wherein the correspondence table distribution evaluation part selects an output candidate in a row that matches input of the distributed secret key.

6. A cryptographic processing method relating to a homomorphic encryption on a torus, the cryptographic processing method being executed by an information processing apparatus including a processor and a memory storing commands executed by the processor;
wherein the cryptographic processing method comprising executing, by using an input-output correspondence table representing a function that receives a distributed secret key and that outputs a value distributed on an algebraic structure different from an algebraic structure on which the secret key is distributed, part of an arithmetic process without decrypting the secret key.

7. The cryptographic processing method according to claim 6; wherein the arithmetic process is a process for decrypting a ciphertext distributed on the algebraic structure different from the algebraic structure on which the secret key is distributed.

8. The cryptographic processing method according to claim 6; wherein the arithmetic process is a process for generating, from a plaintext, a ciphertext distributed on the algebraic structure different from the algebraic structure on which the secret key is distributed.

9. The cryptographic processing method according to claim 6; wherein the arithmetic process is a process for generating an operation key for operating a ciphertext distributed on the algebraic structure different from the algebraic structure on which the secret key is distributed, without decrypting the ciphertext.

10. A non-transitory computer readable medium storing a cryptographic processing program relating to a homomorphic encryption on a torus, the cryptographic processing program being executed by an information processing apparatus including a processor and a memory storing commands executed by the processor;
wherein the cryptographic processing program comprising a process for executing, by using an input-output correspondence table representing a function that receives a distributed secret key and that outputs a value distributed on an algebraic structure different from an algebraic structure on which the secret key is distributed, part of an arithmetic process without decrypting the secret key.

11. The non-transitory computer readable medium storing the cryptographic processing program relating to a homomorphic encryption on a torus according to claim 10; wherein the arithmetic process is a process for decrypting a ciphertext distributed on the algebraic structure different from the algebraic structure on which the secret key is distributed.

12. The non-transitory computer readable medium storing the cryptographic processing program relating to a homomorphic encryption on a torus according to claim 10; wherein the arithmetic process is a process for generating, from a plaintext, a ciphertext distributed on the algebraic structure different from the algebraic structure on which the secret key is distributed.

13. The non-transitory computer readable medium storing the cryptographic processing program relating to a homomorphic encryption on a torus according to claim 10; wherein the arithmetic process is a process for generating an operation key for operating a ciphertext distributed on the algebraic structure different from the algebraic structure on which the secret key is distributed, without decrypting the ciphertext.

14. The non-transitory computer readable medium storing the cryptographic processing program relating to a homomorphic encryption on a torus according to claim 10;
wherein in the correspondence table, an input candidate of the distributed secret key and an output candidate distributed on the algebraic structure different from the algebraic structure on which the secret key is distributed are listed in a single row; and
wherein the information processing apparatus selects an output candidate in a row that matches input of the distributed secret key.

15. The cryptographic processing method according to claim 6;
wherein in the correspondence table, an input candidate of the distributed secret key and an output candidate distributed on the algebraic structure different from the algebraic structure on which the secret key is distributed are listed in a single row; and
wherein the information processing apparatus selects an output candidate in a row that matches input of the distributed secret key.
